(19) United States
(12) Patent Application Publication
(10) Pub. No.: US 2026/0080259 A1
(43) Pub. Date: Mar. 19, 2026

(54) GENERATIVE ARTIFICIAL INTELLIGENCE ("GENAI") USER EXPERIENCE ENHANCER

(71) Applicant: Bank of America Corporation, Charlotte, NC (US)

(72) Inventors: Sasikumar Purushothaman, Frisco, TX (US); Manu Kurian, Dallas, TX (US)

(21) Appl. No.: 18/889,550

(22) Filed: Sep. 19, 2024

(51) Int. Cl. G06N 3/094; G06Q 30/0282

(52) U.S. Cl. CPC G06N 3/094; G06Q 30/0282

(57) ABSTRACT

A method that uses a graphics processing unit (“GPU”) to train and run a generative adversarial network (“GAN”) model to make enhancements to an online tool provided by the organization. The user may communicate with the organization to seek enhancements to the online tool. The method may include collecting a dataset and training the GAN model with records of previous contact between the user and the contact center relating to the online tool, the user's posts on social media relating to the online tool, and the user's answers to a survey provided by the organization relating to use of the online tool. A processor may run the GAN model to provide a suggestion to the agent before and during the contact center communication with the user for how to best interact to enhance the user's experience.

### FIELD OF TECHNOLOGY

Aspects of the disclosure relate to the use of generative artificial intelligence (“GenAI”) to enhance a user experience.

### BACKGROUND

A user may communicate with a contact center of an organization when they need assistance. The agent at the contact center may not benefit from a long history of interaction between the user and the organization because the history of that interaction may not be saved or may not be accessible quickly enough to have an influence on the interaction.

Sometimes there are patterns in contact center behavior and/or user behavior. And sometimes there are messages hidden within these patterns. It would therefore be advantageous to analyze contact center and/or user behaviors to recognize the patterns within, and to more effectively interact with users.

Additionally, there may be more global considerations that are affecting users. It would be beneficial for a contact center agent to have an awareness of the factors affecting communication with users.

There is a need for analyzing available data to enhance the service an organization provides to a user. The user may have an expectation that the organization learns from previous interactions between themselves and the user. Lack of access to records of previous interactions may result in inferior service provided to the user. Lack of access to records of previous interactions may result in the user seeking service from a different organization.

There is a need to provide enhanced service to a user in real-time. When a user engages with a contact center of an organization, the user may have an expectation that an agent at the contact center has access to records from previous interactions. An agent that does not have real-time access to these records may not provide guidance to the user based on historical interactions. Lack of access to records of previous interactions in real-time may result in inferior service provided by the agent to the user. Lack of access to records of previous interactions in real-time may result in the user seeking service from a different organization.

There is a need to provide enhanced service to a user who has experienced a data incident. There is a need to provide enhanced service to a user who has experienced a data breach. The user may be more agitated if they experienced a data incident or a data breach. The probability of an unfavorable interaction may be increased. There is a need for an agent in the contact center of an organization to be aware of factors affecting the user in real-time.

### SUMMARY

It is an object of the disclosure to provide systems and methods for enhanced service to a user by an organization by utilizing data available from various sources. The service may be provided by an online tool provided by the organization. Sources may include previous interactions between the organization, such as an agent at the organization, and the user. Interactions may include those related to the user's utilization of the online tool. Sources may include feedback provided by the user on social media relating to the user's experience with the online tool.

It is an object of the disclosure to provide systems and methods for providing enhanced service to a user in real-time by an organization, such as by an agent at the organization, utilizing data available from various sources. The service may pertain to utilization by the user of an online tool provided by the organization. Sources may include previous interactions between the organization, such as the agent at the organization, and the user. Interactions may include those related to the user's utilization of the online tool. Sources may include feedback provided by the user on social media relating to the user's experience with the online tool. Enhanced real-time service may include an agent at a contact center of the organization providing service during a communication with the user that utilizes information obtained about the user and their use of the online tool.

It is an object of the disclosure to provide systems and methods for providing enhanced service to a user who has experienced a data incident and/or a data breach. The user may be more agitated if they experienced a data incident and/or a data breach. The probability of an unfavorable interaction may be increased. It is an object of the disclosure for an agent in a contact center to know in real-time factors that may affect the user such as experiencing a data incident and/or data breach.

Apparatus and processes may provide for a real-time enhancement to an experience of a user when the user communicates with a contact center of an organization. The processes may include a method for a real-time enhancement to an experience of a user when the user communicates with a contact center of an organization, such as with an agent at the contact center.

A method that operates a system of one or more processors may be configured to perform operations or actions by virtue of having software, firmware, and/or hardware installed on the system that in operation cause the system to perform the actions. The one or more processors may include a graphics processing unit (“GPU”). The one or more processors may include a central processing unit (“CPU”). The CPU may manage computing tasks for the operating system and applications. The CPU may be suited to a wide variety of tasks, especially those that are important for latency or per-core performance. Performance per core is a metric that measures how well each core in a multi-core processor performs.

The method may include using a GPU to collect the first dataset from sources. The first dataset may be used to train the GAN model. The sources may include records within the organization relating to communications of contact center agents with multiple users of an online tool about their experiences using the online tool. The sources may include feedback posted on social media by multiple users relating to their use of the online tool. The feedback may be a rating of the online tool and/or comments relating to their use of the online tool. The sources may include results of a survey provided by the organization to multiple users that includes questions relating to use of the online tool. Questions relating to the use of the online tool may include identifying problems encountered when using the online tool and/or identifying suggestions for improvement of the online tool.

The method may include a GPU. The GPU may be used to perform all steps. The GPU may be used to perform the steps that include training and/or running the GAN model.

The method may include a CPU. The CPU may be used to perform steps other than the steps done to train and/or run the GAN model.

One or more computer programs may be configured to perform operations or actions by virtue of including instructions that, when executed by data processing apparatus, cause the apparatus to perform the actions. One general aspect may include a method for providing a real-time enhancement to an experience of a user when the user communicates with a contact center or an organization. The user may communicate with the contact center because of an issue that arose when using an online tool of an organization and/or to seek an enhancement to the online tool. The user may communicate with the contact center by voice, chatbot, online portal, email, short message service (“SMS”), multimedia messaging service (“MMS”), texting, instant messaging (“IM”), and/or iMessages.

The online tool may provide online services to the user. The services may include providing an overview of a user's account such as with an online dashboard, comparisons to benchmarks of products across an industry, a research platform for learning more about a selected topic, a search platform to look for information about various accounts of the user, a search platform based on a library of resources on a selected topic, and customer service to the user.

The method may include using the GPU to store the first dataset in a data warehouse and/or a database. The data warehouse may include a central repository that stores data from multiple sources to support analytics and reporting. The data warehouse may store historical and current data from across an organization. Data stored at the data warehouse may be used to generate insights through analysis and queries.

The database may include a collection of organized data that can be easily accessed, managed, and updated. The database may store data for a specific unit within an organization. The database may be designed for fast queries and request processing.

The method may include using the GPU and the first dataset to train a generative adversarial network (“GAN”) model to produce suggestions in real-time for improving a user experience when a user communicates with an agent at the contact center of the organization. The GPU may be a specialized hardware designed for efficiently processing large blocks of data simultaneously. The GPU may be a preferred processor for accelerating complex computations that may be encountered when training the GAN.

The GAN model may produce suggestions for improving a user experience when a user communicates with an agent in the contact center of the organization. The GAN model may include neural networks. The neural networks may include a generator model and/or a discriminator model.

The generator model may produce suggestions for improving user experience. The discriminator model may determine the accuracy of the produced suggestions for improving a user experience from the generator model against genuine data of suggestions for improving a user experience such as is provided by the first dataset. The generator model and the discriminator model may work together in an adversarial manner until the GAN model is trained to accurately produce suggestions for improving a user experience.

The method may include using the second dataset to train the GAN model. The GAN model may produce a first suggestion in real-time and may provide the first suggestion in real-time to a first agent in a contact center of the organization in real-time to enhance an experience of a first user when the first user communicates with the first agent in the contact center of the organization. The first user may communicate with the contact center by voice, chatbot, online portal, email, short message service (“SMS”), multimedia messaging service (“MMS”), texting, instant messaging (“IM”), and/or iMessages.

The second dataset may include a record within the organization relating to communication of a contact center agent with the first user of an online tool about their experience using the online tool. The second dataset may include feedback posted on social media by the first user relating to their use of the online tool. The feedback may be a rating of the online tool and/or comments relating to their use of the online tool. The second dataset may include the results of a survey provided by the organization to the first user that includes questions relating to use of the online tool. Questions relating to the use of the online tool may include identifying problems encountered when using the online tool and/or identifying suggestions for improvement of the online tool.

The method may run the GAN model. The GAN model may produce a first suggestion and may provide the first suggestion to a first agent in a contact center of the organization in real-time to enhance an experience of a first user when the first user communicates with the first agent in the contact center of the organization. The first user may communicate with the contact center by voice, chatbot, online portal, email, short message service (“SMS”), multimedia messaging service (“MMS”), texting, instant messaging (“IM”), and/or iMessages.

The method may include using the GPU to implement the first suggestion in real-time to enhance the experience of the first user when using the online tool. The implementation of the first suggestion may include a modification to the online tool. The modification to the online too may include a change to a graphical user interface used by the first user, an addition of a capability to the online tool to provide decision-critical information to the first user, a removal of an existing capability of the online tool that the first user reported as unhelpful, a modification of self-directed customer service provided in the online tool, a modification of live help provided in the online tool that includes a chat feature, and/or an increase in a duration of tenancy of a role in a team that supports the online tool.

The first suggestion in real-time to enhance the experience of the first user when using the online tool may include a recommendation for how to make the online tool more effective for the first user and/or how to overcome a technical difficulty the first user is experiencing when using the online tool. The action may include improving the service offered by the online tool. The improvement in service may include keeping staff that help to run the service provided by the online tool for a predetermined length of time such as 1 year, 2 years, or 3 years. The first suggestion may include providing financial incentives and/or discounts to the user to continue using the online tool. The first suggestion may include advice to exhibit a skill and/or a quality such as a recommendation to an agent to exhibit patience with the first user.

The method may include using the GPU to collect information about whether the first user experienced a data incident and/or data breach. When the first user experienced a data incident and/or data breach, the GAN model may produce a first suggestion and may provide the first suggestion to the first agent to conduct a conversation with the first user exhibiting a skill and/or quality, said skill and/or quality comprising patience. The suggestion may include a skill and/or a quality such as a recommendation to an agent to exhibit patience with the user. The agent may conduct a conversation with the first user where the agent may exhibit the skill and/or quality.

A data incident may include an event that compromises a company's security policy. A data breach may include an event that compromises a company's data such as the data being accessed without authorization, including authorized access by a third party. A data incident may be managed internally. A data breach may require external reporting and response.

Implementations of the described techniques may include hardware, a method or process, or computer software on a computer-accessible medium.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1A shows an illustrative block diagram in accordance with principles of the disclosure;

FIG. 1B shows an illustrative block diagram in accordance with principles of the disclosure;

FIG. 2 shows an illustrative flowchart in accordance with principles of the disclosure;

FIG. 3 shows an illustrative flowchart in accordance with principles of the disclosure;

FIG. 4 shows an illustrative block diagram in accordance with principles of the disclosure; and

FIG. 5 shows an illustrative block diagram in accordance with principles of the disclosure.

### DETAILED DESCRIPTION

A system of one or more processors may be configured to perform operations or actions by virtue of having software, firmware, and/or hardware installed on the system that in operation cause the system to perform the actions. The one or more processors may include a graphics processing unit (“GPU”).

The one or more processors may include a central processing unit (“CPU”). The CPU may manage computing tasks for the operating system and applications. The CPU may be suited to a wide variety of tasks, especially those that are important for latency or per-core performance. Performance per core is a metric that measures how well each core in a multi-core processor performs.

One or more computer programs may be configured to perform operations or actions by virtue of including instructions that, when executed by data processing apparatus, cause the apparatus to perform the actions. One general aspect may include a system for providing a real-time enhancement to an experience of a user when the user communicates with a contact center or an organization. The user may communicate with the contact center because of an issue that arose when using an online tool of an organization and/or to seek an enhancement to the online tool.

The system may include a generative adversarial network (“GAN”) model. The GAN model may include neural networks. The neural networks may include a generator model and/or a discriminator model.

The system may include a GPU. The GPU may be used to train the GAN model. The GPU may be used to run the GAN model. The GPU may be a specialized hardware designed for efficiently processing large blocks of data simultaneously. The GPU may be a preferred processor for accelerating complex computations that may be encountered when training the GAN.

The system may include a CPU. The CPU may be used to perform steps other than the steps done to train and/or run the GAN model.

The system may include datasets. The system may include a dataset used to train the GAN model. The system may include a dataset used to run the GAN model such as a dataset that includes data specific to a user who is communicating with the contact center. The user may communicate with the contact center by voice, chatbot, online portal, email, short message service (“SMS”), multimedia messaging service (“MMS”), texting, instant messaging (“IM”), and/or iMessages.

The system may include an online tool. The online tool may provide online services to the user. The services may include providing an overview of a user's account such as with an online dashboard, comparisons to benchmarks of products across an industry, a research platform for learning more about a selected topic, a search platform to look for information about various accounts of the user, a search platform based on a library of resources on a selected topic, and customer service to the user.

The GPU may be configured to train the GAN model. The GPU may be configured to run the GAN model. The GPU may be configured to collect dataset from sources. The sources may include records within the organization relating to communications of contact center agents with multiple users of an online tool about their experiences using the online tool. The sources may include feedback posted on social media by multiple users relating to their use of the online tool. The feedback may be a rating of the online tool and/or comments relating to their use of the online tool. The sources may include results of a survey provided by the organization to multiple users that includes questions relating to use of the online tool. Questions relating to the use of the online tool may include identifying problems encountered when using the online tool and/or identifying suggestions for improvement of the online tool.

The GPU may be configured to store the dataset in a data warehouse and/or a database. The data warehouse may include a central repository that stores data from multiple sources to support analytics and reporting. The data warehouse may store historical and current data from across an organization. Data stored at the data warehouse may be used to generate insights through analysis and queries.

The database may include a collection of organized data that can be easily accessed, managed, and updated. The database may store data for a specific unit within an organization. The database may be designed for fast queries and request processing.

The GPU may be configured to train a GAN model. The GAN model may produce suggestions in real-time for improving a user experience when a user communicates with an agent in the contact center of the organization. The GAN model may include neural networks. The neural networks may include a generator model and a discriminator model.

The generator model may produce suggestions for improving user experience. The discriminator model may determine the accuracy of the produced suggestions for improving a user experience from the generator model against genuine data of suggestions for improving a user experience such as is provided by the first dataset. The generator model and the discriminator model may work together in an adversarial manner until the GAN model is trained to accurately produce suggestions for improving a user experience.

The GPU may be configured to train, using the second dataset, the GAN model. The GAN model may produce a first suggestion in real-time and may provide the first suggestion in real-time to a first agent in a contact center of the organization in real-time to enhance an experience of a first user when the first user communicates with the first agent in the contact center of the organization. The first user may communicate with the contact center by voice, chatbot, online portal, email, short message service (“SMS”), multimedia messaging service (“MMS”), texting, instant messaging (“IM”), and/or iMessages.

The second dataset may include a record within the organization relating to communication of a contact center agent with the first user of an online tool about their experience using the online tool. The second dataset may include feedback posted on social media by the first user relating to their use of the online tool. The feedback may be a rating of the online tool and/or comments relating to their use of the online tool. The second dataset may include the results of a survey provided by the organization to the first user that includes questions relating to use of the online tool. Questions relating to the use of the online tool may include identifying problems encountered when using the online tool and/or identifying suggestions for improvement of the online tool.

The GPU may be configured to run the GAN model. The GAN model may produce a first suggestion and may provide the first suggestion to a first agent in a contact center of the organization in real-time to enhance an experience of a first user when the first user communicates with the first agent in the contact center of the organization. The first user may communicate with the contact center by voice, chatbot, online portal, email, short message service (“SMS”), multimedia messaging service (“MMS”), texting, instant messaging (“IM”), and/or iMessages.

The GPU may be configured to implement the first suggestion in real-time to enhance the experience of the first user when using the online tool. The implementation of the first suggestion may include a modification to the online tool. The modification to the online too may include a change to a graphical user interface used by the first user, an addition of a capability to the online tool to provide decision-critical information to the first user, a removal of an existing capability of the online tool that the first user reported as unhelpful, a modification of self-directed customer service provided in the online tool, a modification of live help provided in the online tool that includes a chat feature, and/or an increase in a duration of tenancy of a role in a team that supports the online tool.

The first suggestion in real-time to enhance the experience of the first user when using the online tool may include a recommendation for how to make the online tool more effective for the first user and/or how to overcome a technical difficulty the first user is experiencing when using the online tool. The action may include improving the service offered by the online tool. The improvement in service may include keeping staff that help to run the service provided by the online tool for a predetermined length of time such as 1 year, 2 years, or 3 years. The first suggestion may include providing financial incentives and/or discounts to the user to continue using the online tool. The first suggestion may include advice to exhibit a skill and/or a quality such as a recommendation to an agent to exhibit patience with the first user.

The GPU may be configured to collect information about whether the first user experienced a data incident and/or data breach. When the first user experienced a data incident and/or data breach, the GAN model may produce a first suggestion and may provide the first suggestion to the first agent to conduct a conversation with the first user exhibiting a skill and/or quality, said skill and/or quality comprising patience. The suggestion may include a skill and/or a quality such as a recommendation to an agent to exhibit patience with the user. The agent may conduct a conversation with the first user where the agent may exhibit the skill and/or quality.

A data incident may include an event that compromises a company's security policy. A data breach may include an event that compromises a company's data such as the data being accessed without authorization, including authorized access by a third party. A data incident may be managed internally. A data breach may require external reporting and response.

Provided may be an apparatus and method for identifying patterns in contact center and/or user behavior. The patterns may be hidden and require a complex GenAI model for identifying the hidden patterns. The GenAI model may provide for realizing these patterns and using them to more effectively interact with a user such as a user of an online tool of an organization. The GenAI model may include a GAN model.

The GenAI and/or GAN model may be built using historical data to enhance a user's experience. Historical data may include capturing a user's interactions and experience from communication with a contact center at an organization such as a call center and/or a service center. Historical data may include collecting what the user has posted on social media such as their own social media accounts and customer reviews for products, services, and/or an organization performing this inquiry.

The historical data may include an online tool provided by the organization. The historical data may provide insights into what the user is saying to the organization and to others about the products, services, and/or organization, including an online tool provided by the organization. Furthermore, the organization may provide a survey to the user focusing on the user on a topic that the organization would like to learn more about, such as the user's opinions about the topic.

For example, the organization may send the user a survey about an online tool the organization offers to find out the user's persistent and/or recurring problems with the online tool, and if the user would like any improvements. The organization may collect the historical data, survey feedback, and store them in a data warehouse and/or in a database. The dataset may be used to run analytics to train a GenAI and/or GAN model.

The data warehouse may include a central repository that stores data from multiple sources to support analytics and reporting. The database may include a collection of organized data that can be easily accessed, managed, and updated.

The organization may collect data and user feedback from multiple sources to train the GAN model. The GAN may include a machine learning model that uses neural networks. These neural networks may include a generator and a discriminator. The generator may learn to produce data that could be mistaken for genuine data. Genuine data may be data obtained from real-world examples. The generator may take a random sample of data and modify it. The generator may produce data through calculated predictions based on weights in its artificial intelligence model.

The discriminator may learn to distinguish the generator's produced data from genuine data. The discriminator may be given batches of data that include both genuine data from real-world examples and produced data generated by the generator. The discriminator may classify the data it receives as genuine or produced.

The generator may adjust its output to produce samples that closely mimic genuine data as it is being trained by using backpropagation to fine-tune its parameters. The generator's ability to generate high-quality, varied samples that may fool the discriminator may be what makes it successful. Backpropagation may include the model providing feedback to the generator to know how far it was from tricking the discriminator.

The produced data that is output from the generator may be directly input into the discriminator. The discriminator may evaluate produced data output by the generator against genuine data, both whose identity has been blinded. These blinded data provide a test for the discriminator. Genuine data may include user data obtained from various sources as described previously.

The discriminator may use backpropagation to send a signal to the generator that guides a GPU controlling the generator to adjust the weighting in the generator model. The backpropagation may include the model providing feedback to the generator to know how far it was from tricking the discriminator. The generator may continue to produce newer versions of produced data until the discriminator no longer is able to tell the difference between produced data and genuine data. At that point, the GAN model may be ready to use to produce suggestions for the organization and/or for an agent in the organization such as an agent in a contact center of the organization.

The generator and the discriminator may be coupled to produce data as their output that is realistic in that it appears to the discriminator to be genuine data. The produced data that is realistic may include a suggestion to the organization and/or an agent within the organization such as in a contact center of the organization. The suggestion may include recommendations for how to make the online tool more effective for the user and how to overcome a technical difficulty the user is experiencing when using the online tool. The action may include improving the service offered by the online tool. The improvement in service may include keeping staff that help to run the service provided by the online tool for a predetermined length of time such as 1 year, 2 years, and/or 3 years. This action may include providing financial incentives and/or discounts to the user to continue using the online tool. The suggestion may include a skill and/or a quality such as a recommendation to an agent to exhibit patience with the user. The agent may conduct a conversation with the user exhibiting the skill and/or quality. The GAN model may provide suggested feedback and suggested next action items based on the user feedback from the various sources.

A potential use case may include providing offline advice for enhancing a user's experience when using an online tool of the organization. The online tool may offer assorted services. The services may be directed by a manager. Feedback the organization may receive from the user and/or other users may include the importance of building a relationship with the manager of the service. The organization may act by keeping managers for at least a certain amount of time such as a 1-year period, a 2-year period, or a 3-year period. Implementing this action may enhance the user's experience.

The GenAI and/or GAN model may identify issues in the form of a report of a problem, a suggestion, and/or feedback. The GenAI and/or GAN model may generate and/or provide a path for solving a problem such as a problem its model identified. From a project management perspective, identification of issues in the form of a report of a problem, a suggestion, and/or feedback may be helpful. It may be helpful to provide a suggested solution. The solution may be in the form of a next-best action (“NBA”) for the team in charge of the online tool to do. NBA may also be referred to as best next action, next best activity, or recommended action.

NBA uses real-time data with artificial intelligence to analyze user needs, preferences, and context. The results of this analysis may assist in the creation of a personalized recommendation that can enhance a user's engagement and satisfaction. For example, NBA could suggest offering a product, resolving an issue, or providing personalized advice.

Another potential use case includes using GenAI and/or GAN model to provide real-time suggestions to enhance the experience of a user of an online tool. For example, a user may communicate with a contact center. The GenAI and/or GAN model may provide a suggestion in real-time to an agent in the contact center. The suggestion may include an action that the agent can put into practice during communication with the user. The suggestion may provide live actionable advice to the agent during communication. The suggestion may enhance the user's experience. The GenAI and/or GAN model may provide a real-time solution to an issue the user is facing. The model may provide word usage to ensure that a user contacting the center has a pleasant experience with the call center such that they would give the best rating to the quality of service they received.

A further use case may include a user experience enhancer when a contact center interacts with a user who recently experienced a data incident. The data incident may include a data breach. Recent may include where the data incident happened within the last 3 months, the last 6 months, the last year, or the last two years. The GenAI and/or GAN model may provide word usage to ensure that a user contacting the center has a pleasant experience with the call center such that they would give the best rating to the quality of service they received.

Included may be a method for providing an enhancement to an experience of a user when using an online tool of an organization. The method may include using a GPU to collect the first dataset from sources. The online tool may provide online services to the user. The services may include providing an overview of a user's account such as with an online dashboard, comparisons to benchmarks of products across an industry, a research platform for learning more about a selected topic, a search platform to look for information about various accounts of the user, a search platform based on a library of resources on a selected topic, and customer service to the user.

The sources may include records within the organization relating to communication of contact center agents with multiple users of an online tool about their experiences using the online tool, feedback posted on social media by the multiple users relating to their use of the online tool, and results of a survey provided by the organization to the multiple users comprising questions relating to use of the online tool. The multiple users may communicate with the contact center by voice, chatbot, online portal, email, short message service (“SMS”), multimedia messaging service (“MMS”), texting, instant messaging (“IM”), and/or iMessages.

The method may include using the GPU to store the first dataset in a data warehouse and/or a database. The data warehouse may include a central repository that stores data from multiple sources to support analytics and reporting. The data warehouse may store historical and current data from across an organization. Data stored at the data warehouse may be used to generate insights through analysis and queries. The database may include a collection of organized data that can be easily accessed, managed, and updated. The database may store data for a specific unit within an organization. The database may be designed for fast queries and request processing.

The method may include using the GPU and the first dataset to train a GAN model to provide suggestions for improving a user experience when a user uses the online tool of the organization. The GPU may be a specialized hardware designed for efficiently processing large blocks of data simultaneously. The GPU may be a preferred processor for accelerating complex computations that may be encountered when training the GAN.

The GAN model may include neural networks. The neural networks may include a generator model and/or a discriminator model. The generator model may produce suggestions for improving user experience. The discriminator model may determine the accuracy of produced suggestions for improving a user experience from the generator model against genuine data to improve a user experience provided by the first dataset. The generator model and the discriminator model may work together in an adversarial manner until the GAN model is trained to accurately provide suggestions for improving a user experience.

The method may include using the GPU and a second dataset to train the GAN model to produce a first suggestion. The method may include providing the first suggestion to the organization to enhance an experience of a first user when the first user uses the online tool. The second data set may include a record within the organization relating to communication of an agent with the first user about the use of the first user of the online tool, feedback posted on social media by the first user relating to their use of the online tool, and/or results of a survey provided by the organization to the first user comprising questions relating to use of the online tool. The first user may communicate with the contact center by voice, chatbot, online portal, email, short message service (“SMS”), multimedia messaging service (“MMS”), texting, instant messaging (“IM”), and/or iMessages.

The second dataset may include a record within the organization relating to communication of a contact center agent with the first user of an online tool about their experience using the online tool. The second dataset may include feedback posted on social media by the first user relating to their use of the online tool. The feedback may be a rating of the online tool and/or comments relating to their use of the online tool. The second dataset may include the results of a survey provided by the organization to the first user that includes questions relating to use of the online tool. Questions relating to the use of the online tool may include identifying problems encountered when using the online tool and/or identifying suggestions for improvement of the online tool.

The method may include using the GPU to run the GAN model to produce a first suggestion. The method may include providing the first suggestion to the organization to enhance an experience of a first user when the first user uses the online tool. The second data set may include a record within the organization relating to communication of an agent with the first user about the use of the first user of the online tool, feedback posted on social media by the first user relating to their use of the online tool, and/or results of a survey provided by the organization to the first user comprising questions relating to use of the online tool. The first user may communicate with the contact center by voice, chatbot, online portal, email, short message service (“SMS”), multimedia messaging service (“MMS”), texting, instant messaging (“IM”), and/or iMessages.

The method may include using the GPU to implement the first suggestion to enhance the experience of the first user when using the online tool. Implementation of the first suggestion may include a modification to the online tool comprising a change to a graphical user interface used by the first user, an addition of a capability to the online tool to provide decision-critical information to the first user, a removal of an existing capability of the online tool that the first user reported as unhelpful, a modification of self-directed customer service provided in the online tool, a modification of live help provided in the online tool that includes a chat feature, and/or an increase in a duration of tenancy of a role in a team that supports the online tool.

Implementations of the described techniques may include hardware, a method or process, or computer software on a computer-accessible medium.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments, such as apparatus and/or methods, may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

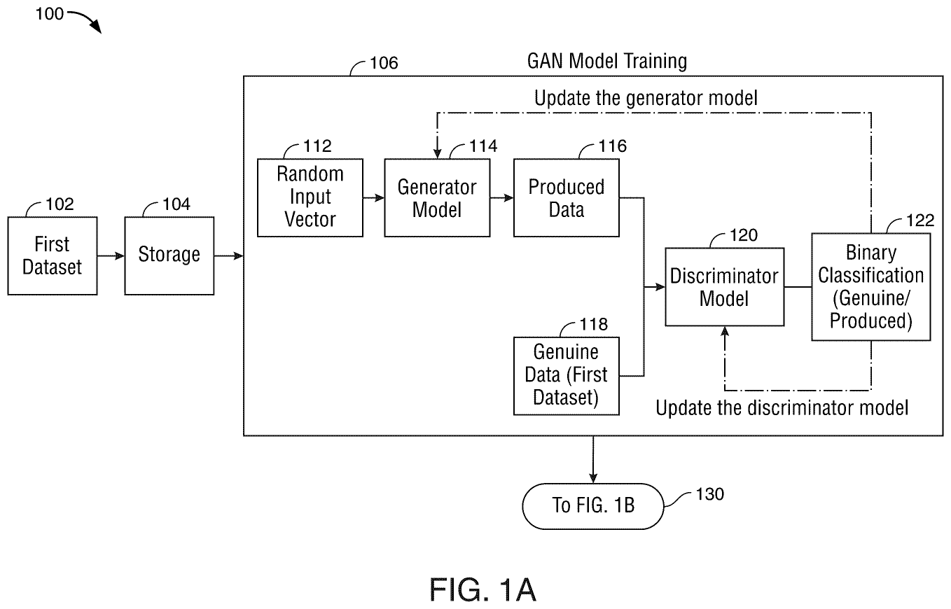

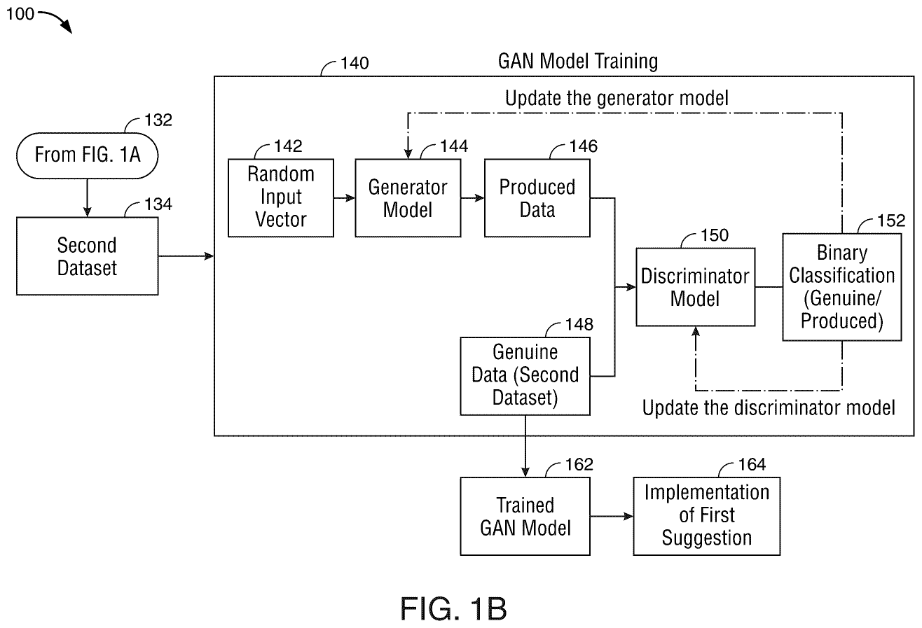

FIG. 1A shows illustrative block diagram 100. Block diagram 100 may be a system. The system may be run on a GPU. The system may include first dataset 102. The system may include storage 104 that may store the first dataset.

The system may include GAN model training 106. GAN model training 106 may include random input vector 112 that may supply random input to generator model 114. Generator model 114 may be a neural network. Generator model 114 may analyze the first dataset 102 to identify data attributes. Data attributes may be properties or characteristics that can be associated with a collection of data.

Generator model 114 may modify data attributes by adding noise and/or making random changes to certain attributes. Generator model 114 may calculate produced data 116. Produced data 116 may include suggestions for improving user experience. Genuine data 118 comes from first dataset 102.

Discriminator model 120 may be a neural network. Discriminator model 120 may analyze the first dataset 102 and distinguish between the attributes independently. Discriminator model 120 may compare produced data 116 and genuine data 118 and make binary classification 122 between genuine and produced data. The discriminator may calculate the probability that the produced data 116 belongs to genuine data 118. Discriminator model 120 may give guidance to generator model 114 to reduce the random input vector 112 in vector randomization in the next cycle. Binary classification 122 may update generator model 114. Binary classification 122 may update generator model 114 using backpropagation. Binary classification 122 may update discriminator model 120. Binary classification 122 may update discriminator model 120 using backpropagation.

Generator 114 may attempt to maximize the probability of mistake by discriminator 120 at binary classification 122. Discriminator 120 may attempt to minimize the probability of error at binary classification 122. As training proceeds, generator 114 and discriminator 120 evolve and may confront each other continuously. Eventually, they may reach an equilibrium state where discriminator 120 can no longer recognize synthesized data. At this point, GAN model training 106 process may be over. The block diagram continues with FIG. 1B at 130.

In FIG. 1B, the block diagram continues with 132. The system may include a second dataset 134. Second dataset 134 may be collected when a first user communicates with the contact center at the organization.

The system may include GAN model training 140. GAN model training 140 may be customized to the first user by using second dataset 134. Second dataset 134 may include a record within the organization relating to communication of an agent with the first user about the use of the first user of the online tool, feedback posted on social media by the first user relating to use of the first user of the online tool, and results of a survey provided by the organization to the first user comprising questions relating to use of the online tool.

GAN model training 140 may include random input vector 142 that may supply random input to generator model 144. Generator model 144 may be a neural network. Generator model 144 may analyze the second dataset 134 to identify data attributes. Data attributes may be properties or characteristics that can be associated with a collection of data.

Generator model 144 may modify data attributes by adding noise and/or make random changes to certain attributes. Generator model 144 may calculate produced data 146. Produced data 146 may include suggestions for improving user experience. Genuine data 148 comes from second dataset 134.

Discriminator model 150 may be a neural network. Discriminator model 150 may analyze the second dataset 134 and distinguish between the attributes independently. Discriminator model 150 may compare produced data 146 and genuine data 148 and make binary classification 152 between genuine and produced data. The discriminator may calculate the probability that the produced data 146 belongs to genuine data 148. Discriminator model 150 may give guidance to generator model 144 to reduce the random input vector 142 in vector randomization in the next cycle. Binary classification 152 may update generator model 144. Binary classification 152 may update discriminator model 150.

Generator 144 may attempt to maximize the probability of mistake by discriminating 150 at binary classification 152. Discriminator 150 may attempt to minimize the probability of error at binary classification 152. As training proceeds, generator 144 and discriminator 150 evolve and may confront each other continuously. Eventually, they may reach an equilibrium state where discriminator 150 can no longer recognize synthesized data. At this point, GAN model training 140 process may be over.

Trained GAN model 162 may be used to produce a first suggestion for the agent to assist the first user. Implementation of first suggestion 164 may implement that first suggestion that is provided by trained GAN model 162.

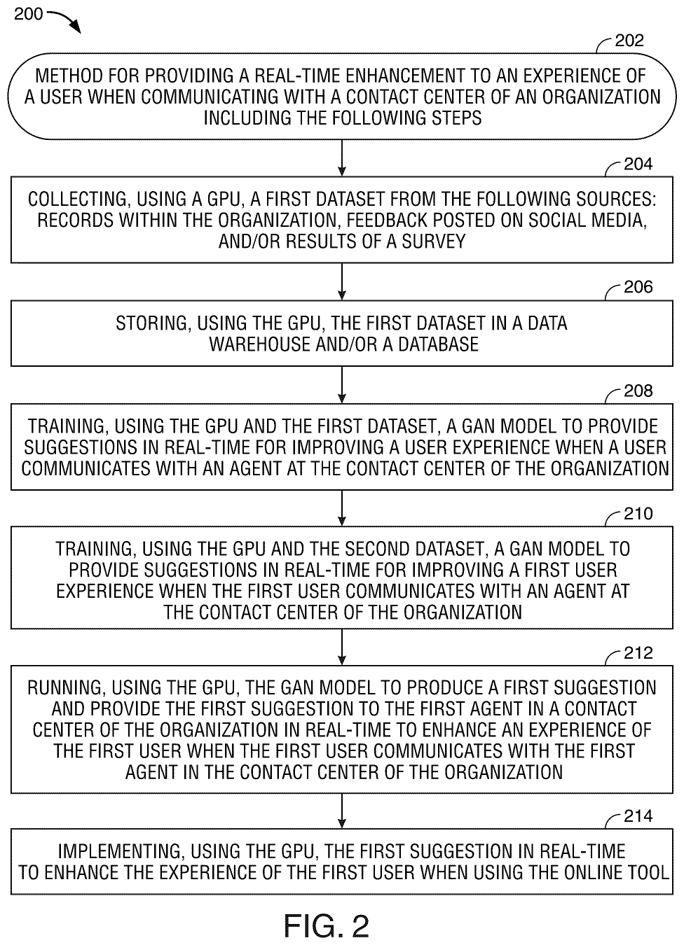

FIG. 2 shows illustrative flowchart 200. Illustrative flowchart 200 may begin at step 202, showing a method for providing a real-time enhancement to an experience of a user when communicating with a contact center of an organization, including the following steps.

The method may continue at step 204 by using a GPU to collect a first dataset from the following sources. A processor may collect the dataset from records within the organization relating to communication of contact center agents with multiple users of an online tool about their experiences using the online tool, feedback posted on social media by the multiple users relating to their use of the online tool, and results of a survey provided by the organization to the multiple users comprising questions relating to use of the online tool.

The online tool may provide online services to the user. The services may include providing an overview of a user's account such as with an online dashboard, comparisons to benchmarks of products across an industry, a research platform for learning more about a selected topic, a search platform to look for information about various accounts of the user, a search platform based on a library of resources on a selected topic, and customer service to the user.

The method may continue at step 206 by using the GPU to store the first dataset in a data warehouse and/or a database. The data warehouse may include a central repository that stores data from multiple sources to support analytics and reporting. The data warehouse may store historical and current data from across an organization. Data stored at the data warehouse may be used to generate insights through analysis and queries. The database may include a collection of organized data that can be easily accessed, managed, and updated. The database may store data for a specific unit within an organization. The database may be designed for fast queries and request processing.

The method may continue at step 208 by using the GPU and the first dataset to train a GAN model to provide suggestions in real-time for improving a user experience when a user communicates with an agent at the contact center of the organization. The user may communicate with the contact center by voice, chatbot, online portal, email, short message service (“SMS”), multimedia messaging service (“MMS”), texting, instant messaging (“IM”), and/or iMessages.

The method may continue at step 210 by using the GPU and the second dataset to train a GAN model to provide suggestions in real-time for improving a user experience when a user communicates with an agent at the contact center of the organization.

The method may continue at step 212 by using the GPU to run the GAN model to produce a first suggestion. The GPU may provide the first suggestion to the first agent in a contact center of the organization in real-time to enhance an experience of the first user when the first user communicates with the first agent in the contact center of the organization.

The method may continue at step 214 by implementing, using the GPU, the first suggestion in real-time to enhance the experience of the first user when using the online tool.

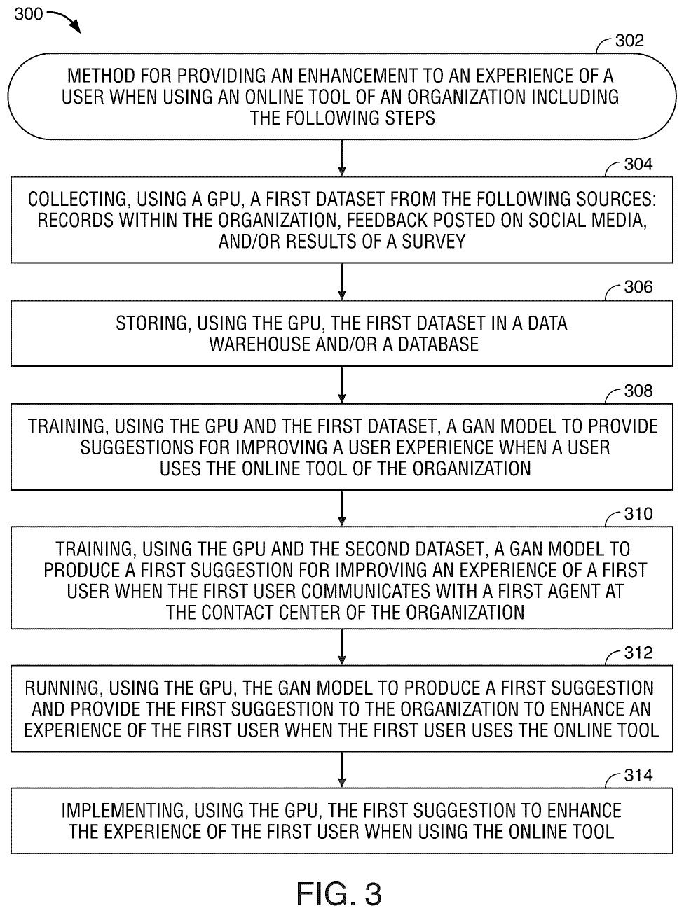

FIG. 3 shows illustrative flowchart 300. Illustrative flowchart 300 may begin at step 302, showing a method for providing an enhancement to an experience of a user that is using an online tool of an organization, including the following steps.

The method may continue at step 304 by using a GPU to collect a first dataset from the following sources. A processor may collect the dataset from records within the organization relating to communication of contact center agents with multiple users of an online tool about their experiences using the online tool, feedback posted on social media by the multiple users relating to their use of the online tool, and results of a survey provided by the organization to the multiple users comprising questions relating to use of the online tool.

The online tool may provide online services to the user. The services may include providing an overview of a user's account such as with an online dashboard, comparisons to benchmarks of products across an industry, a research platform for learning more about a selected topic, a search platform to look for information about various accounts of the user, a search platform based on a library of resources on a selected topic, and customer service to the user.

The method may continue at step 306 by using the GPU to store the first dataset in a data warehouse and/or a database. The data warehouse may include a central repository that stores data from multiple sources to support analytics and reporting. The data warehouse may store historical and current data from across an organization. Data stored at the data warehouse may be used to generate insights through analysis and queries. The database may include a collection of organized data that can be easily accessed, managed, and updated. The database may store data for a specific unit within an organization. The database may be designed for fast queries and request processing.

The method may continue at step 308 by using the GPU and the first dataset to train a GAN model to provide suggestions for improving a user experience when a user uses an online tool of the organization.

The method may continue at step 310 by using the GPU and the second dataset to train a GAN model to provide suggestions for improving a first user's experience when the first user uses an online tool of the organization.

The method may continue at step 312 by using the GPU to run the GAN model to produce a first suggestion and provide the first suggestion to the organization to enhance an experience of the first user when the first user uses the online tool.

The method may continue at step 214 by implementing, using the GPU, the first suggestion to enhance the experience of the first user when using the online tool.

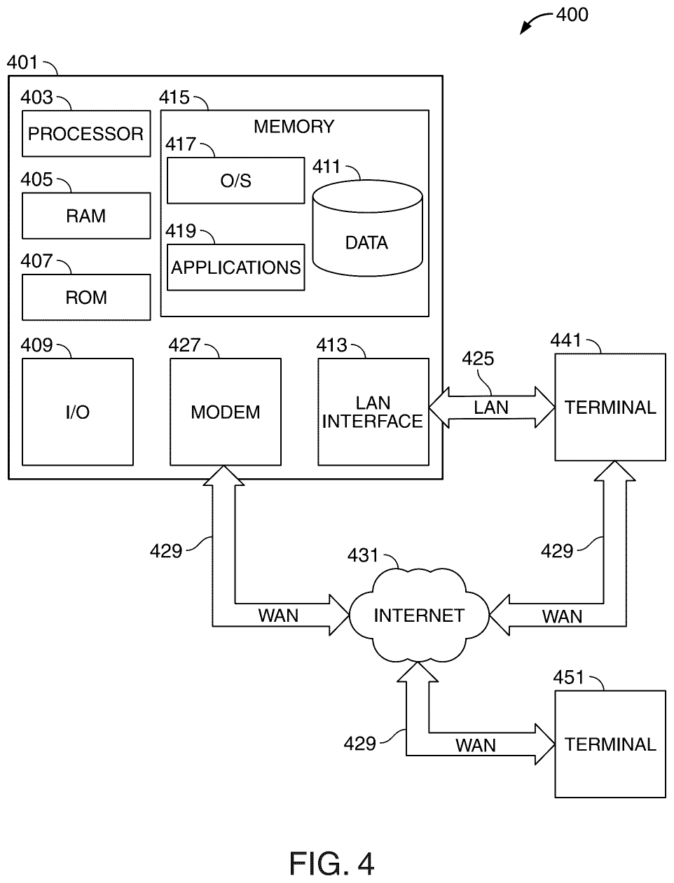

FIG. 4 shows an illustrative block diagram of system 400 that includes computer 401. Computer 401 may alternatively be referred to herein as an “engine,” “server” or a “computing device.” Computer 401 may be a workstation, desktop, laptop, tablet, smartphone, or any other suitable computing device. Elements of system 400, including computer 401, may be used to implement various aspects of the systems and methods disclosed herein. Each of the systems, methods and algorithms illustrated below may include some or all the elements and apparatus of system 400.

Computer 401 may have a processor 403, including a central processing unit (“CPU”), for controlling the operation of the device and its associated components, and may include RAM 405, ROM 407, input/output (“I/O”) 409, and a non-transitory or non-volatile memory 415. Machine-readable memory may be configured to store information in machine-readable data structures. Processor 403 may also execute all software running on the computer. Other components, such as graphics processing unit (“GPU”), EEPROM, Flash memory, neural-network processing elements, or any other suitable components, may also be part of the computer 401.

Memory 415 may be comprised of any suitable permanent storage technology—e.g., a hard drive. Memory 415 may store software including the operating system 417 and application program(s) 419 along with any data 411 needed for the operation of the system 400. Memory 415 may also store videos, text, and/or audio assistance files. The data stored in memory 415 may also be stored in cache memory, or any other suitable memory.

I/O module 409 may include connectivity to a microphone, keyboard, touch screen, mouse, and/or stylus through which input may be provided into computer 401. The input may include input relating to cursor movement. The input/output module may also include one or more speakers for providing audio output and a video display device for providing textual, audio, audiovisual, and/or graphical output. The input and output may be related to computer application functionality.

System 400 may be connected to other systems via a local area network interface 413. System 400 may operate in a networked environment supporting connections to one or more remote computers, such as terminals 441 and 451. Terminals 441 and 451 may be personal computers or servers that include many, or all the elements described above relative to system 400. The network connections depicted in FIG. 4 include a local area network (“LAN”) 425 and a wide area network (“WAN”) 429 but may also include other networks. When used in a LAN networking environment, computer 401 is connected to LAN 425 through LAN interface 413 or an adapter. When used in a WAN networking environment, computer 401 may include a modem 427 or other means for establishing communications over WAN 429, such as Internet 431.

It will be appreciated that network connections shown are illustrative and other means of establishing a communications link between computers may be used. The existence of various well-known protocols such as TCP/IP, Ethernet, FTP, HTTP, and the like is presumed, and the system can be operated in a client-server configuration to permit retrieval of data from a web-based server or an API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 419, which may be used by computer 401, may include computer executable instructions for invoking functionality related to communication, such as e-mail, Short Message Service (“SMS”), and voice input and speech recognition applications. Application program(s) 419 (which may be alternatively referred to herein as “plugins,” “applications,” or “apps”) may include computer executable instructions for invoking functionality related to performing various tasks. Application program(s) 419 may utilize one or more algorithms that process received executable instructions, perform power management routines or other suitable tasks.

Application program(s) 419 may include computer executable instructions (alternatively referred to as “programs”). The computer executable instructions may be embodied in hardware or firmware (not shown). Computer 401 may execute the instructions embodied by the application program(s) 419 to perform various functions.

Application program(s) 419 may utilize the computer-executable instructions executed by a processor. Programs may include routines, programs, objects, components, data structures, etc., that perform tasks or implement abstract data types. A computing system may be operational with distributed computing environments. Tasks may be performed by remote processing devices that are linked through a communications network. In a distributed computing environment, a program may be in both local and remote computer storage media including memory storage devices. Computing systems may rely on a network of remote servers hosted on the Internet to store, manage, and process data (e.g., “cloud computing” and/or “fog computing”).

Any information described above in connection with data 411, and any other suitable information, may be stored in memory 415.

The invention may be described in the context of computer-executable instructions, such as application(s) 419, being executed by a computer. Programs may include routines, programs, objects, components, data structures, etc., that perform tasks or implement data types. The invention may also be practiced in distributed computing environments. Tasks may be performed by remote processing devices that are linked through a communications network. In a distributed computing environment, programs may be in both local and remote computer storage media including memory storage devices. It should be noted that such programs may be considered for the purposes of this application as engines with respect to the performance of the tasks to which the programs are assigned.

Computer 401 and/or terminals 441 and 451 may also include various other components, such as a battery, speaker, and/or antennas (not shown). Components of computer system 401 may be linked by a system bus, wirelessly or by other suitable interconnections. Components of computer system 401 may be present on one or more circuit boards. In some embodiments, the components may be integrated into a single chip. The chip may be silicon-based.

Terminal 441 and/or terminal 451 may be portable devices such as a laptop, cell phone, tablet, smartphone, or any other computing system for receiving, storing, transmitting, and/or displaying relevant information. Terminal 441 and/or terminal 451 may be one or more user devices. Terminals 441 and 451 may be identical to system 400 or different. Differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

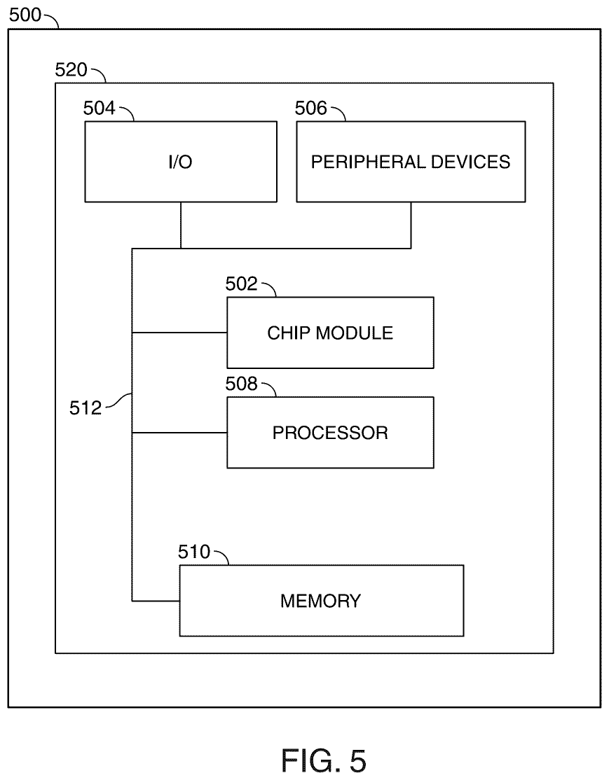

FIG. 5 shows illustrative apparatus 500 that may be configured in accordance with the principles of the disclosure. Apparatus 500 may be a computing device. Apparatus 500 may include one or more features of the apparatus shown in FIG. 5. Apparatus 500 may include chip module 502, that may include one or more integrated circuits, and that may include logic configured to perform any other suitable logical operations.

Apparatus 500 may include one or more of the following components: I/O circuitry 504, that may include a transmitter device and a receiver device and may interface with fiber optic cable, coaxial cable, telephone lines, wireless devices, PHY layer hardware, a keypad/display control device or any other suitable media or devices; peripheral devices 506, that may include counter timers, real-time timers, power-on reset generators or any other suitable peripheral devices; logical processing device 508, that may compute data structural information and structural parameters of the data; and machine-readable memory 510.

Machine-readable memory 510 may be configured to store in machine-readable data structures: machine executable instructions, (which may be alternatively referred to herein as “computer instructions” or “computer code”), applications such as applications 119 (shown in FIG. 1), signals, and/or any other suitable information or data structures.

A system bus or other interconnections 512 may couple components 502, 504, 506, 508 and 510 and may be present on one or more circuit boards such as circuit board 520. In some embodiments, a single chip may integrate the components. The chip may be silicon-based.

Thus, provided may be systems and methods relating to use of GenAI and/or GAN to enhance a user experience. Persons skilled in the art will appreciate that the present invention can be practiced by other than the described embodiments, which are presented for purposes of illustration rather than of limitation. The present invention is limited only by the claims that follow.

What is claimed is:

1. A system for providing a real-time enhancement to an experience of a user when the user communicates with a contact center of an organization, the system comprising:
a generative adversarial network (“GAN”) model, said GAN model comprising neural networks, said neural networks comprising a generator model and a discriminator model;
a graphics processing unit (“GPU”), said GPU for use in training and running the GAN model; and
an online tool, said online tool provides online services to a user;
the GPU is configured to:
collect a first dataset from sources comprising:
records within the organization relating to communication of contact center agents with multiple users of an online tool about their experiences using the online tool, feedback posted on social media by the multiple users relating to their use of the online tool, and results of a survey provided by the organization to the multiple users comprising questions relating to use of the online tool;
store the first dataset in a data warehouse and/or a database;
train, with use of the first dataset, the GAN model to produce suggestions in real-time for improving a user experience when a user communicates with an agent at the contact center of the organization;
wherein said GAN model comprises neural networks, said neural networks comprising a generator model and a discriminator model;
said generator model produces suggestions for improving a user experience;
said discriminator model determines an accuracy of produced suggestions for improving a user experience from the generator model against genuine data to improve a user experience provided by the first dataset; and
the generator model and the discriminator model work together in an adversarial manner until the GAN model is trained to accurately provide suggestions for improving a user experience;
train, with use of a second dataset, the GAN model to produce a first suggestion in real-time for improving an experience of a first user when the first user communicates with a first agent at the contact center of the organization;
wherein the second dataset comprises a record within the organization relating to communication of an agent with the first user about the use of the first user of the online tool, feedback posted on social media by the first user relating to use of the first user of the online tool, and results of a survey provided by the organization to the first user comprising questions relating to use of the online tool;
run the GAN model to produce the first suggestion and provide the first suggestion to the first agent in real-time in a contact center of the organization in real-time to enhance an experience of the first user when the first user communicates with the first agent in the contact center of the organization; and
implement the first suggestion in real-time to enhance the experience of the first user when using the online tool;
wherein implementation of the first suggestion comprises a modification to the online tool comprising a change to a graphical user interface used by the first user, an addition of a capability to the online tool to provide decision-critical information to the first user, a removal of an existing capability of the online tool that the first user reported as unhelpful, a modification of self-directed customer service provided in the online tool, a modification of live help provided in the online tool that includes a chat feature, and/or an increase in a duration of tenancy of a role in a team that supports the online tool.

2. The system of claim 1 wherein the feedback posted on social media comprises feedback and/or rating provided by the multiple users and/or the first user relating to their use of the online tool.

3. The system of claim 1 wherein the results of the survey provided by the organization to the multiple users and/or the first user comprises answers to questions directed toward identifying problems encountered when using the online tool and/or to identify suggestions for improvement of the online tool.

4. The system of claim 1 wherein the first suggestion for improving a user experience comprises recommending how to make the online tool more effective for the first user, recommending how to overcome a technical difficulty the first user is experiencing when using the online tool, improving a service offered by the online tool, and/or providing financial incentives and/or discounts to the first user to continue using the online tool.

5. The system of claim 1 wherein the first user communicates with the contact center by voice, chatbot, online portal, email, short message service (“SMS”), multimedia messaging service (“MMS”), texting, instant messaging (“IM”), and/or iMessages.

6. The system of claim 1 further comprising collecting information about whether the first user experienced a data incident and/or data breach, and when the first user experienced a data incident and/or data breach, the GAN model produces the first suggestion and provides the first suggestion to the first agent to conduct a conversation with the first user exhibiting a skill and/or quality, said skill and/or quality comprising patience.

7. The system of claim 1 wherein the online tool provides a service to the user, said service comprises providing a graphical interface that gives a user an overview of their accounts, a comparison across an industry, a research platform for education about a selected topic, a search tool to look for information about various accounts of the user, a search platform to search a selected topic, and/or a customer service function for the user.

8. A method for providing a real-time enhancement to an experience of a user when the user communicates with a contact center of an organization, the method comprising:
collecting, using a graphics processing unit (“GPU”), a first dataset from sources comprising:
records within the organization relating to communication of contact center agents with multiple users of an online tool about their experiences using the online tool, feedback posted on social media by the multiple users relating to their use of the online tool, and results of a survey provided by the organization to the multiple users comprising questions relating to use of the online tool;
storing, using the GPU, the first dataset in a data warehouse and/or a database;
training, using the GPU and the first dataset, a generative adversarial network (“GAN”) model to produce suggestions in real-time for improving a user experience when a user communicates with an agent at the contact center of the organization;
wherein said GAN model comprises neural networks, said neural networks comprising a generator model and a discriminator model;
said generator model produces suggestions for improving a user experience;
said discriminator model determines an accuracy of produced suggestions for improving a user experience from the generator model against genuine data to improve a user experience provided by the first dataset; and
the generator model and the discriminator model work together in an adversarial manner until the GAN model is trained to accurately provide suggestions for improving a user experience;
training, using the GPU and a second dataset, the GAN model to produce a first suggestion in real-time for improving an experience of a first user when the first user communicates with a first agent at the contact center of the organization;
wherein the second dataset comprises a record within the organization relating to communication of an agent with the first user about the use of the first user of the online tool, feedback posted on social media by the first user relating to their use of the online tool, and results of a survey provided by the organization to the first user comprising questions relating to use of the online tool;
running, using the GPU, the GAN model to produce a first suggestion and provide the first suggestion to the first agent in real-time in a contact center of the organization in real-time to enhance an experience of the first user when the first user communicates with the first agent in the contact center of the organization; and
implementing, using the GPU, the first suggestion in real-time to enhance the experience of the first user when using the online tool;
wherein implementation of the first suggestion comprises a modification to the online tool comprising a change to a graphical user interface used by the first user, an addition of a capability to the online tool to provide decision-critical information to the first user, a removal of an existing capability of the online tool that the first user reported as unhelpful, a modification of self-directed customer service provided in the online tool, a modification of live help provided in the online tool that includes a chat feature, and/or an increase in a duration of tenancy of a role in a team that supports the online tool.

9. The method of claim 8 wherein the feedback posted on social media comprises feedback and/or rating provided by the multiple users and/or the first user relating to their use of the online tool.

10. The method of claim 8 wherein the results of the survey provided by the organization to the multiple users and/or the first user comprises answers to questions directed toward identifying problems encountered when using the online tool and/or to identify suggestions for improvement of the online tool.

11. The method of claim 8 wherein the first suggestion for improving a user experience comprises recommending how to make the online tool more effective for the first user, recommending how to overcome a technical difficulty the first user is experiencing when using the online tool, improving a service offered by the online tool, and/or providing financial incentives and/or discounts to the first user to continue using the online tool.

12. The method of claim 8 wherein the first user communicates with the contact center by voice, chatbot, online portal, email, short message service (“SMS”), multimedia messaging service (“MMS”), texting, instant messaging (“IM”), and/or iMessages.

13. The method of claim 8 further comprising collecting information about whether the first user experienced a data incident and/or data breach, and when the first user experienced a data incident and/or data breach, the GAN model produces the first suggestion and provides the first suggestion to the first agent to conduct a conversation with the first user exhibiting a skill and/or quality, said skill and/or quality comprising patience.

14. The method of claim 8 wherein the online tool provides a service to the user, said service comprises providing a graphical interface that gives a user an overview of their accounts, a comparison across an industry, a research platform for education about a selected topic, a search tool to look for information about various accounts of the user, a search platform to search a selected topic, and/or a customer service function for the user.

15. A method for providing an enhancement to an experience of a user when using an online tool of an organization, the method comprising:
collecting, using a graphics processing unit (“GPU”), a first dataset from sources comprising:
records within the organization relating to communication of contact center agents with multiple users of an online tool about their experiences using the online tool, feedback posted on social media by the multiple users relating to their use of the online tool, and results of a survey provided by the organization to the multiple users comprising questions relating to use of the online tool;
storing, using the GPU, the first dataset in a data warehouse and/or a database;
training, using the GPU and the first dataset, a generative adversarial network (“GAN”) model to provide suggestions for improving a user experience when a user uses the online tool of the organization;
wherein said GAN model comprises neural networks, said neural networks comprising a generator model and a discriminator model;
said generator model produces suggestions for improving a user experience;
said discriminator model determines an accuracy of produced suggestions for improving a user experience from the generator model against genuine data to improve a user experience provided by the first dataset; and
the generator model and the discriminator model work together in an adversarial manner until the GAN model is trained to accurately provide suggestions for improving a user experience;
training, using the GPU and a second dataset, the GAN model to produce a first suggestion for improving an experience of a first user when the first user communicates with a first agent at a contact center of the organization;
wherein the second data set comprises a record within the organization relating to communication of an agent with the first user about the use of the first user of the online tool, feedback posted on social media by the first user relating to their use of the online tool, and results of a survey provided by the organization to the first user comprising questions relating to use of the online tool;
running, using the GPU, the GAN model to produce a first suggestion and provide the first suggestion to the organization to enhance an experience of the first user when the first user uses the online tool; and
implementing, using the GPU, the first suggestion to enhance the experience of the first user when using the online tool;
wherein implementation of the first suggestion comprises a modification to the online tool comprising a change to a graphical user interface used by the first user, an addition of a capability to the online tool to provide decision-critical information to the first user, a removal of an existing capability of the online tool that the first user reported as unhelpful, a modification of self-directed customer service provided in the online tool, a modification of live help provided in the online tool that includes a chat feature, and/or an increase in a duration of tenancy of a role in a team that supports the online tool.

16. The method of claim 15 wherein the results of the survey provided by the organization to the multiple users and/or the first user comprises answers to questions directed toward identifying problems encountered when using the online tool and/or to identify suggestions for improvement of the online tool.

17. The method of claim 15 wherein the first suggestion for improving a user experience comprises recommending how to make the online tool more effective for the first user, recommending how to overcome a technical difficulty the first user is experiencing when using the online tool, improving a service offered by the online tool, and/or providing financial incentives and/or discounts to the first user to continue using the online tool.

18. The method of claim 15 wherein the first user communicates with the contact center by voice, chatbot, online portal, email, short message service (“SMS”), multimedia messaging service (“MMS”), texting, instant messaging (“IM”), and/or iMessages.

19. The method of claim 15 further comprising collecting information about whether the first user experienced a data incident and/or data breach, and when the first user experienced a data incident and/or data breach, the GAN model produces the first suggestion and provides the first suggestion to the first agent to conduct a conversation with the first user exhibiting a skill and/or quality, said skill and/or quality comprising patience.

20. The method of claim 15 wherein the online tool provides a service to the user, said service comprises providing a graphical interface that gives a user an overview of their accounts, a comparison across an industry, a research platform for education about a selected topic, a search tool to look for information about various accounts of the user, a search platform to search a selected topic, and/or a customer service function for the user.
